(19) United States
(12) Patent Application Publication
(10) Pub. No.: US 2024/0058960 A1
(43) Pub. Date: Feb. 22, 2024

(54) ROBOT WITH SEVEN OR MORE DEGREES OF FREEDOM

(71) Applicant: Dexterity, Inc., Redwood City, CA (US)

(72) Inventors: Avinash Verma, Fremont, CA (US); Robert Holmberg, Mountain View, CA (US); Gil Matzliach, Sunnyvale, CA (US); Luis Sentis, Austin, TX (US); Salvador Perez, Jersey City, NJ (US); Samir Menon, Atherton, CA (US); Zhouwen Sun, Redwood City, CA (US)

(21) Appl. No.: 18/233,260

(22) Filed: Aug. 11, 2023

Related U.S. Application Data
(60) Provisional application No. 63/397,765, filed on Aug. 12, 2022.

(51) Int. Cl. B25J 9/16; B25J 17/02

(52) U.S. Cl. CPC B25J 9/1664; B25J 17/0283

(57) ABSTRACT

A robot having seven or more degrees of freedom is disclosed. In various embodiments, the robot includes a positioning robot having m degrees of freedom and a manipulator robot having n degrees of freedom coupled to the positioning robot. The robot is configured to be operated in a first mode of operation, in which the positioning robot is controlled to position move the manipulator robot into a position to perform a task and the manipulator robot is controlled independently of the positioning robot to perform the task; and in a second mode of operation, in which at least a subset of the m degrees of freedom of the positioning robot and at least a subset of the n degrees of freedom of the manipulator robot are controlled together, by a single controller, to perform the task.

### CROSS REFERENCE TO OTHER APPLICATIONS

This application claims priority to U.S. Provisional Patent Application No. 63/397,765 entitled ROBOT WITH SEVEN OR MORE DEGREES OF FREEDOM filed Aug. 12, 2022 which is incorporated herein by reference for all purposes.

### BACKGROUND OF THE INVENTION

Industrial robots perform a variety of tasks. In many contexts, robots may be used to pick items from one location and place the items in another location, such as to assemble a kit or fulfill an order, invoice, or other requirement.

Robots may be used to handle items that have a variety of shapes, sizes, and weights, as well as varying characteristics such as rigidity, pliability, durability, strength, smoothness, etc.

A robotic arm having six degrees of freedom (DOF) is commonly used. A 6 DOF robotic arm typically has three segments, including a base (proximal) segment, which may be rotatably mounted on a stationary or mobile base (providing a first DOF); a middle segment mounted via a first motor-driven hinge joint (sometimes referred to as a “shoulder” joint) at a first end to the distal end of the base segment (second DOF) and by a second motor-driven hinge joint (sometimes referred to as an “elbow” joint) at a second (distal) end to the proximal end of the third segment (third DOF). A wrist assembly and end effector typically are provided at the free moving distal end of the third segment, the wrist assembly providing three additional DOFs (roll, pitch, and yaw).

The typical 6 DOF robot provides flexibility and control to relatively freely pick and place objects within a certain operating envelope or portion of three-dimensional space. Kinematic, dynamic, and/or other models of the robot and its elements and attributes may be used to control the robot, e.g., to pick and place items autonomously under control of a computer.

Typically, care is taken to ensure the safety of nearby human workers and to avoid damaging the robot, items being handled by the robot, or structures present in the workspace. Speed may be desired, to increase throughout, and accuracy may be required.

In some contexts, the desired speed and accuracy may not be attained, with required safety, using a conventional 6 DOF robot.

### BRIEF DESCRIPTION OF THE DRAWINGS

Various embodiments of the invention are disclosed in the following detailed description and the accompanying drawings.

FIG. 1 illustrates an embodiment of a robot with seven or more degrees of freedom.

FIG. 2 illustrates an embodiment of a system comprising one or more robots having seven or more degrees of freedom.

FIG. 3 is a flow diagram illustrating an embodiment of a process to control a robot having seven or more degrees of freedom.

FIG. 4 is a flow diagram illustrating an embodiment of a process to train a model to be used to control a robot having seven or more degrees of freedom.

FIG. 5 illustrates an embodiment of a compact design for a robot joint to provide three or more degrees of freedom.

FIG. 6 illustrates an embodiment of a robot with m+n degrees of freedom.

FIG. 7 illustrates an embodiment of a robot with m+n degrees of freedom.

FIG. 8A is a flow diagram illustrating an embodiment of a process to control a robot having m+n degrees of freedom.

FIG. 8B is a flow diagram illustrating an embodiment of a process to move a robot having m+n degrees of freedom into position to perform a task.

FIG. 9 illustrates an embodiment of a robot comprising two robotic arms.

FIG. 10 illustrates an embodiment of a robot comprising two robotic arms.

FIG. 11 illustrates an embodiment of a robot comprising two robotic arms.

FIG. 12 illustrates an embodiment of a robot comprising two robotic arms.

FIG. 13 illustrates an embodiment of a robot comprising two robotic arms.

FIG. 14 illustrates an embodiment of a robot comprising two robotic arms.

FIG. 15 illustrates an embodiment of a robot comprising two robotic arms.

FIG. 16 is a flow diagram illustrating an embodiment of a process to control a robot comprising two robotic arms.

FIG. 17 is a flow diagram illustrating an embodiment of a process to control a robot comprising two robotic arms.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Robots having seven or more degrees of freedom are disclosed. In various embodiments, additional degrees of freedom are provided by including one or more additional arm segments beyond the three segments typically included in a 6 DOF robot and/or by mounting the robotic arm on a structure that provides and additional DOF, such as a chassis that translates along a rail or other linear guide or drive or cam or similar structure configured to be rotated, under robotic control, about an additional axis.

In various embodiments, the additional DOF(s) improves kinematics of a robot as disclosed herein, as compared to a conventional 6 DOF industrial robot. For example, additional DOF(s) may reduce or make it easier to avoid “singularities” that may be encountered when using a conventional 6 DOF robot, e.g., due to the segments of the arm being placed in an awkward pose or one or more joints or segments interfering with each other or the environment.

In various embodiments, all available DOFs may be modeled and used in real time to control a robot as disclosed herein. Motor and gearbox improvements disclosed herein may be used to reduce the weight of the arm—since adding segments and joints, including associated motors/controllers, would otherwise increase weight and may reduce the speed and operation of a robot. In some embodiments, lighter weight materials, such as aluminum tube, carbon fiber, or plastic, may be used for structures comprising a robotic arm as disclosed herein, to reduce weight and improve performance. Robots may be built certified to either ISO 10218 Part-1 or ANSPRIA R15.06 Part-1 and achieve prescribed safety requirements, such as safety rated e-stop. In some embodiments, individual joint/axis level safety and/or multi-axis safety is provided. In some embodiments, safety rated soft axis and space limiting requirements are met.

In some embodiments, a robot as disclosed herein may have seven or eight or more plus one DOF. For example, a robot as disclosed herein may comprised a robotic arm have seven, eight, or more degrees of freedom and be mounted on a structure that provides an additional degree of freedom. In some embodiments, the robotic control system may determine, e.g., based on rules, criteria, heuristics, sensor data, strategies learned over time by machine learning, etc., to perform a given task using all available DOFs (e.g., n DOFs of arm or other manipulator plus one or m>1 DOF associated with a robotically controlled “positioning” robot or other robotically-controlled positioning structure on which n DOF robot is mounted) in an integrated manner, sometimes referred to herein as “whole body” control, or instead to use the m DOF positioner to position the n DOF robot in a position from which the n DOF robot can (more readily) perform the task.

In some embodiments, weight savings and/or performance gains may be achieved by integrated joint motor controllers with their associated motors, eliminating the complexity and weight associated with running wires from each centrally located controller to its associated motor. Robot weight to payload ratios from 1:8-10 to 1:2-3 are achieved, in some embodiments.

In various embodiments, a robot as disclosed herein may have 7-9 DOF. The additional DOF improve dexterity and/or reduce robot null space, as compared to a conventional 6 DOF robot, in various embodiments. Robots having seven or more joints, with alternating roll and pitch joints, e.g., RPRPRPR, are provided in some embodiments. In some embodiments, an additional DOF is provided by mounting a 7 to 9 DOF robot on a structure at a 45 degree or other angle (e.g., to ground or other reference plane), to provide an additional DOF and further reach/flexibility.

The additional DOFs, in various embodiments, provide greater flexibility, especially when working in a truck, shipping container, or other constrained space. For example, an additional joint makes it possible to rotate the robot's “elbow” out of the way, e.g., to avoid contacting a wall or other adjacent structure. The additional joint also offers increased ability to move through the same trajectory faster, without encountering or having to go through less efficient trajectories to avoid singularities.

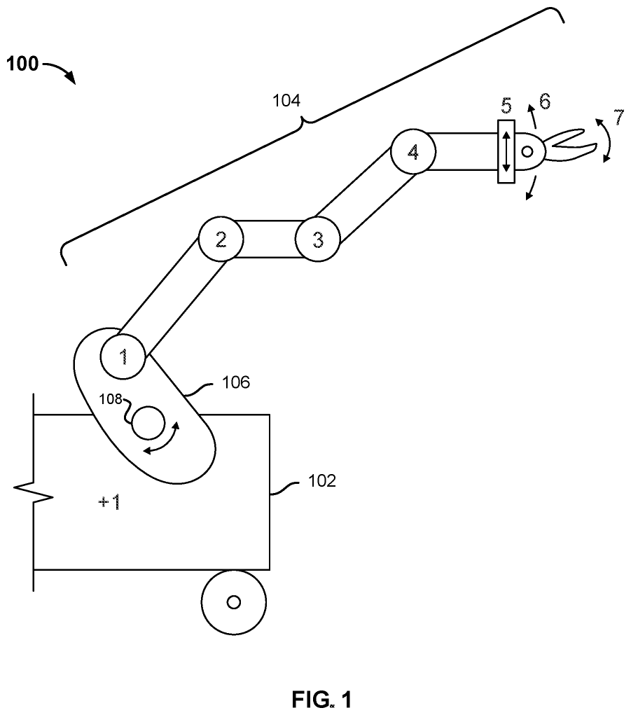

FIG. 1 illustrates an embodiment of a robot with seven or more degrees of freedom. In the example shown, robot 100 includes a robotically-controlled mobile base 102 on which a 7 DOF robotic arm 104 is mounted via a robotically-controlled positioning cam 106. Robotic arm 104 includes 7 DOF, numbered “1” through “7”, including DOFs associated with a shoulder joint (“1”), three elbow joints (“2”, “3”, and “4”) and a wrist assembly (including roll axis “5”, pitch axis “6”, and yaw axis “7”). In the example shown, robotically-controlled positioning cam 106 provides an additional (“+1”) DOF about rotation axis 108, which in this example is offset from the mount point at which shoulder joint “1” of robotic arm 104 is mounted to the positioning cam 106. In various embodiments, the mobile base 102 may be operated via robotic control to position the mobile base and the structures mounted thereon to perform a task. Once mobile base 102 is in position, or as mobile base 102 arrives at its destination position, in some embodiments, positioning cam 106 may be used to pitch the robotic arm 104 forward, e.g., to enable a remote or more remote object to be reached by operating the 7 DOF robotic arm 104. To reach a higher position, such as to grasp or place a box or other item on the top of a stack or on/from a high shelf, positioning cam 106 may be positioning in a vertical orientation that places the shoulder (joint “1”) of robotic arm 104 at a higher position (e.g., above the floor). The positioning cam 106 may be rotated back, for example, to facilitate using the robotic arm 104 to grasp an item from (or place an item in) a position near the mobile base 102, e.g., on the ground near the mobile base 102.

In some embodiments, all 7+1 DOFs of the robotic arm 104 and positioning cam 106 may be operated in an integrated manner to provide “whole body” control to perform a task. For example, a model of the kinematics of the combined structures (104, 106) may be used to operate the robotic arm 104 and positioning cam 106 as a single 8 DOF robot. In some embodiments, whole body control may be used selectively, e.g., to perform a subset of tasks, such as certain types or tasks, or tasks performed in certain conditions or contexts. Alternatively, the robot 100 may be operated as a 7+1 DOF robot, with the positioning cam 106 being positioned in one control action, e.g., to put the 7 DOF robotic arm 104 into a desired position, and the 7 DOF robotic arm being controlled independently of the “+1” DOF (i.e., positioning cam 106, in this example) to perform the task.

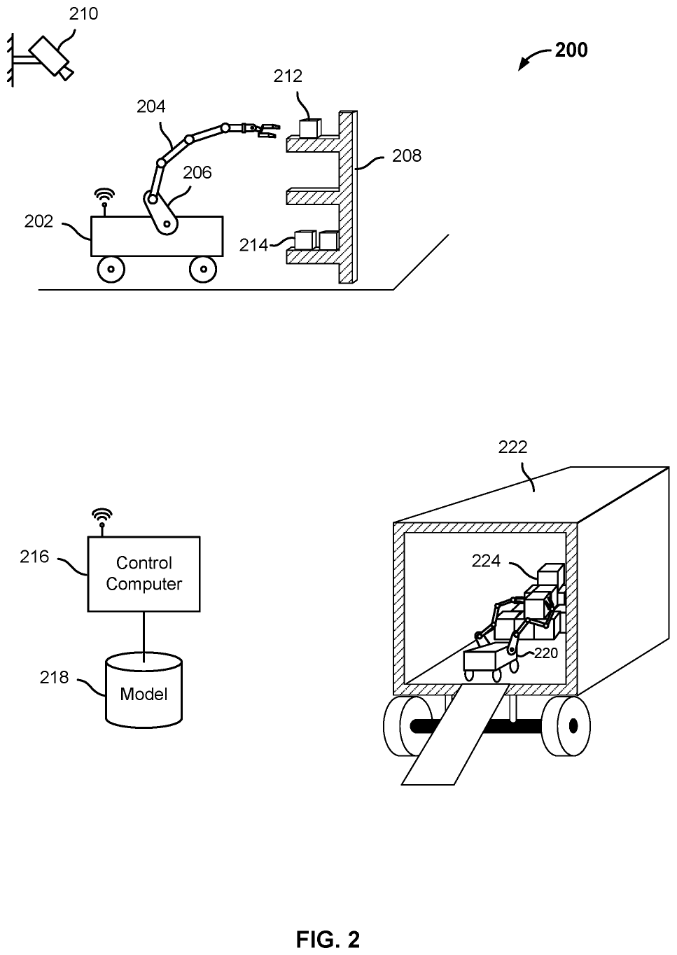

FIG. 2 illustrates an embodiment of a system comprising one or more robots having seven or more degrees of freedom. In the example shown, robotic system and environment 200 includes a first 7+1 DOF robot comprising a robotically controlled mobile base 202 and 7 DOF robotic arm 204 mounted to mobile base 202 via positioning cam 206. The first 7+1 DOF robot (202, 204, 206) is shown in an environment that includes a shelf 208 within view of a wall-mounted camera 210. In various embodiments, sensor data generated by camera 210, e.g., RGB and/or depth pixel data, may be used to control first 7+1 DOF robot (202, 204, 206) to perform tasks in the environment shown, e.g., to pick/place items from/to shelf 208, such as items 212, 214.

In the example shown, the first 7+1 DOF robot (202, 204, 206) is configured to communicate, via wireless communication, with a control computer 216. Control computer 216 is configured to use one or more kinematic models 218 to control the first 7+1 DOF robot (202, 204, 206). To perform certain tasks, the control computer 216 may use separate kinematic models for the robotic arm 204 and positioning cam 206, e.g., to operate positioning cam 206 under robotic control to position the robotic arm 204 into a position from which the robotic arm 204 can be operated, using a kinematic model of the 7 DOF of the robotic arm 204, to perform a task. For example, the positioning cam 206 may be moved into a vertical orientation to enable the robotic arm 204 to (more readily) reach item 212 from the top shelf of shelf 208, or positioning cam 206 may be moved into an orientation as shown in FIG. 2 to enable the robotic arm 204 to (more readily) reach item 214 from the bottom shelf. To perform other tasks, the control computer 216 may used a kinematic model that incorporates all 8 DOF of the positioning cam 206 and robotic arm 204, combined, to perform “whole body” control. For example, all 8 joints, or any subset thereof, may be moved, in a determined sequence and combination, to operate the positioning cam 206 and robotic arm 204 as a single, 8 DOF robot, such as to move item 212 from the top shelf to the middle shelf of shelf 208.

Referring further to FIG. 2, the system and environment 200 further includes a second robot 220, shown working inside a truck or trailer 222 to load (or unload) boxes 224. For example, the mobile base of robot 220 may have been operated, under robotic control, to drive the robot 220 up the ramp and into the position within truck or trailer 222, as shown. In the example shown, robot 220 includes two 7+1 DOF robotic arms, each comprising a 7 DOF arm mounted to the mobile base via a robotically controlled positioning cam. In this example, robot 220 may be controlled by the same control computer 216 or another control computer, e.g., based on sensor data generated by 3D cameras or other sensors mounted on, near, or in the truck or trailer 222 and/or on the robot 220, for example.

In various embodiments, a robot having two or more robotic arms, each having 7 or more DOF, may be controlled in a first mode of operation, in which each robotic arm is controlled separately to perform tasks independently, in a manner that avoid collisions or inefficiency, such as long wait times for one arm as the other performs one or more tasks, or in a second mode of operation, sometimes referred to as “bimanual manipulation”, in which the robotic arms are used cooperatively to perform a task jointly, such as to pick up a large or heavy item. In various embodiments, sensor data may be used to determine the respective attributes of items to be handled and/or to determine and/or determine the order of the tasks to be performed. For some tasks, both robotic arms may be used together, as shown in FIG. 2, to pick or place a large or heavy item. At other times, each arm may be used independently to perform tasks, such as picking and placing smaller or lighter items.

In various embodiments, whether the arms are used separately or together, one or both of them may be controlled in the manner described above in connection with the robot 100 of FIG. 1. That is, one or both of the robotic arms may be operated in one of two control modes, either “whole body” or as a +1 DOF positioning structure used to position a separately-controlled 7 DOF arm (sometimes referred to herein as m+n control, to generalize to arbitrary numbers of m DOF for the positioning robot/structure and n DOF for the manipulating robot/structure).

While the robot 220 shown in FIG. 2 has two 7+1 DOF robotic arms, in other embodiments a robot as disclosed herein may include three or more such arms and/or may include one or more robotic arms that are not 7+1 DOF robotic arms as disclosed herein.

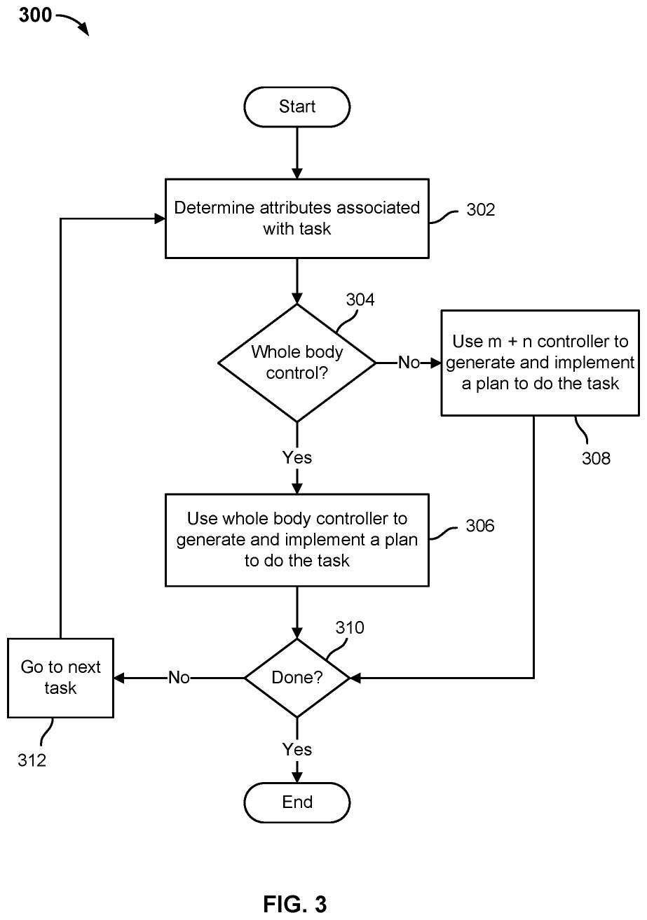

FIG. 3 is a flow diagram illustrating an embodiment of a process to control a robot having seven or more degrees of freedom. In various embodiments, the process 300 of FIG. 3 may be performed by a control computer comprising a robotic system, such as control computer 216 of FIG. 2. In the example shown, at 302, attributes associated with a task are determined. For example, camera or other sensor data may be used to determine the attributes of an item to be picked and placed by a robot, such as the dimensions, weight, rigidity, fragility, etc. At 304, a determination is made as to whether the task will be performed using “whole body” control, as described above. For example, one or more rules, heuristics, learned strategies, or other techniques may be applied to determine whether to use “whole body” control to perform the task. If it is determined at 304 to use “whole body” control, then at 306 a “whole body” controller is used to generate and implement a plan to use all or a subset of all available DOFs to perform the task. If it is instead determined at 304 that “whole body” control will not be used, then at 308 an m+n controller is used to generate and implement a plan to perform the task, e.g., using all or some of m DOFs of a positioning robot/structure (e.g., positioning cam 106 of FIG. 1) to position a manipulator robot having n DOFs to perform the task.

While in the example shown in FIG. 3 steps 304, 306, and 308 are illustrated as being performed separately and sequentially, in some embodiments one or more of them may be performed simultaneously and/or in parallel or during overlapping intervals and/or in a different order than as shown in FIG. 3. For example, steps 306 and 308 each may be performed, wholly or partly, to generate plans to perform the task using “whole body” control (306) and m+n control (308), respectively, and the resulting plans may be evaluated (e.g., by comparing associated costs, scores, weights, weighted scores, etc.) to determine (at 304) whether “whole body” or m+n control will be used.

Referring further to FIG. 3, at 310, once a plan to do the task has been determined and implemented (306, 308), the process 300 ends if there are no other tasks to be performed or, at 312, proceeds to a next task if further tasks remain. Subsequent iterations of 302, 304, 306, 308, and 310 are performed, as applicable, until no tasks remain, at which time the process 300 of FIG. 3 ends.

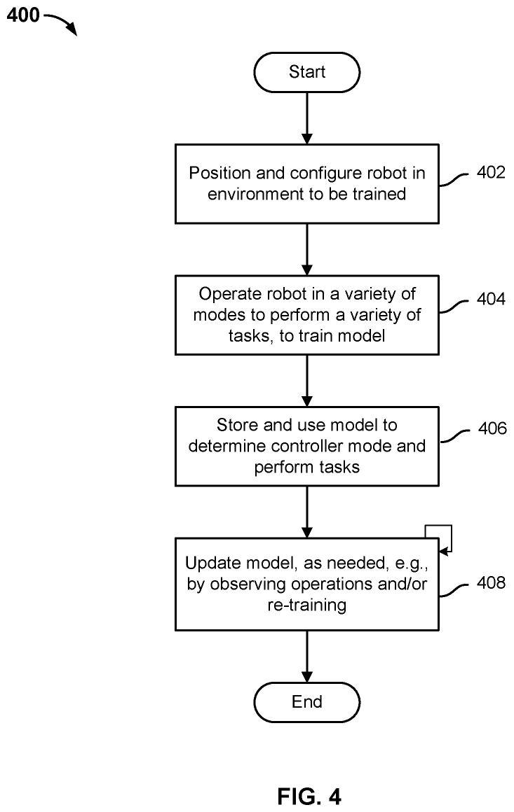

FIG. 4 is a flow diagram illustrating an embodiment of a process to train a model to be used to control a robot having seven or more degrees of freedom. In various embodiments, the process 400 of FIG. 4 may be performed to train a robotic control system to determine whether to use “whole body” control or to instead use m+n control, as in step 304 of FIG. 3, and/or to learn strategies to perform tasks using either “whole body” control or m+n control, as in steps 306 and 308 of FIG. 3, respectively. In the example shown, at 402, a robot is positioned in a training environment and configured to be used/trained. For example, the robot may be positioned in an environment set up to be used to train the robot to perform a specific set or range of tasks. Items of mixed or uniform size may be placed in source locations to train the robot to pick and place them in destination locations in the training environment. Cameras (e.g., 3D cameras that provide RGB and depth pixels) and/or other sensors may be positioned in the workspace or on the robot. Computer vision may be used to perceive a current state of the environment and/or to observe as the robot is used to perform a range of tasks.

At 404, the robot is operated in a variety of modes to perform a range of tasks. Machine learning is used to train a model to be used later to determine autonomously which mode of operation to use (e.g., “whole body” control versus m+n control) and/or to learn strategies to grasp, move, and/or place items. For example, a human operator may control the robot via teleoperation to perform a task. The task may be repeated by the human operator in different modes of operation, with different obstacles or safety considerations present, etc. The robot may be operated in an autonomous mode, e.g., using a previously trained model, and the outcomes and challenges may be observed by the system and machine learning (e.g., artificial intelligence) techniques may be used to regenerate or refine the model to make better decisions as to the mode of operation in which to operate and/or the plans and strategies to be used in each mode (e.g., to perform a given task in a given context).

At 406, the model generated or improved at 404 is stored, see, e.g., model 218 of FIG. 2, and the robotic control system is configured to use the model to perform tasks. At 408, the model is updated, e.g., through further training or retraining, as needed. For example, autonomous operations may be observed in a production (as opposed to training) environment and observed results may be used to update the model.

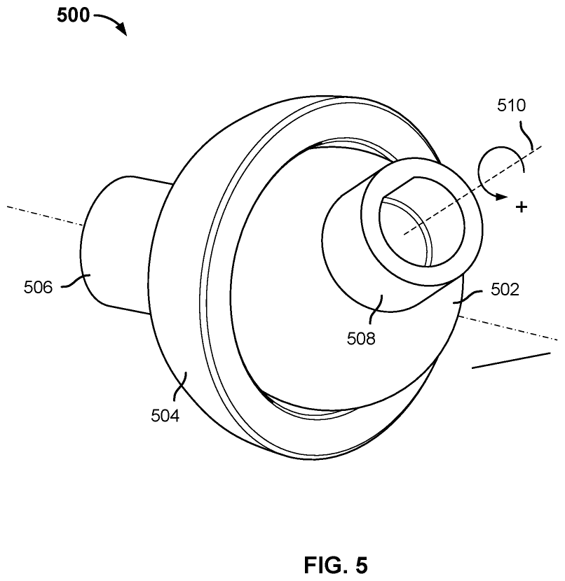

FIG. 5 illustrates an embodiment of a compact design for a robot joint to provide three or more degrees of freedom. In the example shown, spherical wrist joint 500 provides 3 DOF in a compact design. Ball portion 502 is positioned in socket portion 504. Socket portion 504 terminates in a forearm segment mount 506 having a first longitudinal axis that is orthogonal to x- (yaw) and y- (pitch) axes that are orthogonal to each other, while ball portion 502 terminates in an end effector mount 510 having a second longitudinal axis about which the ball portion 502 may be rotated (roll).

In various embodiments, spherical wrist joint 500 provides wrist dexterity in a compact design at least in part by having roll, pitch, and/or yaw be as near to one another as possible.

In some embodiments, the spherical wrist joint 500 uses gears, wheels, or other drive mechanisms, such as having magnet(s) and two (or more) magnetic fields used to create a magnetic field to pull/push the ball in different directions, to provide roll, pitch, and yaw motions.

Providing a 7 or greater DOF robot, in various embodiments, requires techniques to reduce the weight associated with traditional robotic arm segments, motors, controllers, and the like. For example, adding segments and joints (and associated motors and motor controllers), in various embodiments, may increase weight and complexity, making it harder and/or costlier to move and control the elements comprising the robotic arm.

In various embodiments, one or more techniques disclosed herein may be used to overcome the above technical difficulty, including by reducing the weight and/or complexity of the 7 or greater DOF robot. Examples include, without limitation, one or more of the following:
Motor design
   Flat wire+Hairpin design
      Better power density, fit more wire and teslas (T) in unit space
      Better cooling transfer—more kilowatts/kg, can drive motors harder
         No extra space, as between cylindrical wires
   Hybrid liquid/air cooling
      Submerged oil, spray oil, etc. to pull heat out much better than convection
      Better fins and/or convection area for better outer surface cooling
      Radiators and pumps on a per axis basis, each motor/joint has own liquid cooling
   Rotor Design
      Halbach array
         Cancels out field on inner rotor to reduce losses
         Magnifies field on outer rotor to amplify magnetic force
         Produces more power/torque with less motor weight
Gearing
   Use of planetary spur gears instead of traditional strain wave
      Don't need the accuracy and backlash reduction of strain wave, therefore we use planetary spur gears, which cost and weigh less
   Lighter, durable gearing provides impact protection and robustness to uncertainty
   More motor power (per weight) allows less gear ratio, which reduces reflected inertia and creates better compliance
   Precise, granular specification of motor duty cycle allows pushing the envelope of power
      Not limited to use of a general-purpose motor with just peak and nominal power
      In some embodiments, motor characterized at 4-5 levels of power, with different duty cycles, and lifetime, to push power to the max
Motor Placement enables lighter, faster robot arm, in some embodiments
   Higher power motors, but placed further towards the root of the robot, reducing lever-arm (i.e., from weight of motor to root)
   Transfer torque through rods and cables or other methods
In some embodiments, lighter/more torque dense motors are used
   Adjust the positions of the arm and compound reducing weight and increasing reach, increasing DOFs
Integrated servo motors and controllers are used in some embodiments to decrease total weight
   Servo drives in very small sizes (55×80×37.6 mm) and high power, e.g., 17 kW
      GaN inverters, soft-switching and other special control may be used for high efficiency
   Servo drives have built in F-Safety for torque limiting, position limiting, stopping speed, position holding—all through F-Safety over Ethercat
      Provide joint level F-Safety
      Provide Boolean joint level safety, e.g., safety stop if joint X exceed torque T1 and joint Y exceeds torque T2; or, can't rotate base (or rotate faster than a certain V) if arm (more) fully extended
      Per joint safety limits: deflection, max V, max torque (T), max V+T
      Reduce safety zone to space enforced by joint level safety
   Integrating servo controllers in the joint gets rid of a control box entirely, in some embodiments
      And only needs to send a single DC power line up the arm, reducing encoder and servo cables entirely
         Cut cost, weight, and/or complexity
Link Materials
   Extremely lightweight and robust materials used in various embodiments
      Plastics—hard plastics that are robust to collision and arm doesn't need to be stiff
      Carbon Fiber (CF) or Aluminum—design for cost and manufacturability—CF thick plates instead of molded designs. More exposed internals but ok for logistics
High redundancy on joints for certain applications (truck loading/unloading, pick/place on or from shelf, etc.)
   Certain environments very hard to maneuver (tight spaces, aisles, low and high, et)
   Extra DoFs for positioning
      Workspace positioning joint ([x,y], or rotary)
      Better conditions robot for the task
   A vertical lifter added to the whole assembly
      Lifts the positioning joints+robot
      Allows high reach applications
         E.g., Palletization/Depalletization
         Reach items at top layer
         Truck or container loading/unloading
         Pack tightly and/or reach items at top level of pile

In various embodiments, a robot as disclosed herein includes a positioning robot having m DOF and a manipulator robot having n DOF. The n DOF manipulator robot may be connected, at a fixed end of the n DOF robot, to a free moving or distal end of the m DOF positioning robot. The m DOF positioning robot may be used to move the n DOF manipulator robot into a position from which the n DOF manipulator robot can perform a task, as described above. In some embodiments, a third robot may be positioned at the free moving end of the n DOF manipulator robot, and so on, each intervening robot in the chain being configured to be used to move one or more robots further down the chain into a position to participate in performing a task.

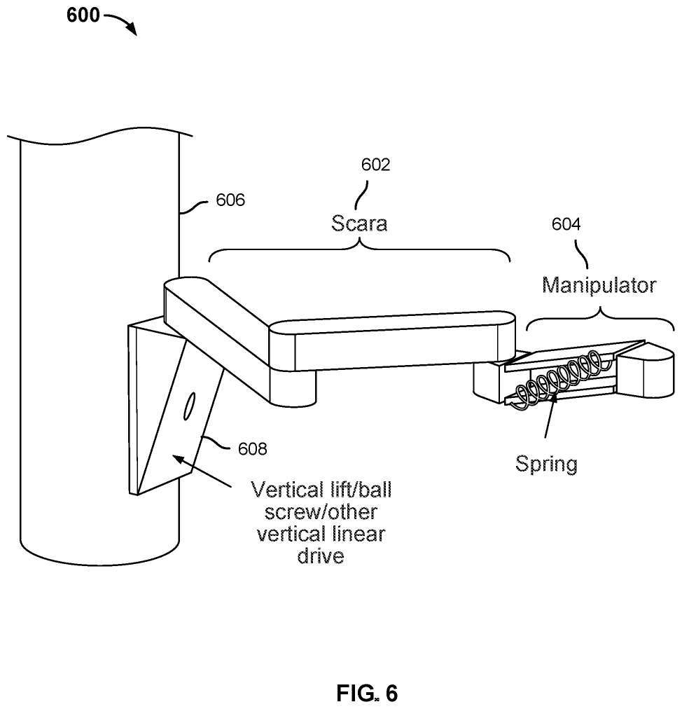

FIG. 6 illustrates an embodiment of a robot with m+n degrees of freedom. In the example shown, robot 600 includes a positioning robot 602, a SCARA (“Selective Articulated Robot Arm”) or other Cartesian robot configured to move a manipulator robot 604 into position. The manipulator robot 604 has 3 DOF in some embodiments (roll, pitch, yaw). In the example shown, manipulator robot 604 includes a spring that provides neutral buoyancy and/or pre-load, to either hold the operative end of the manipulator robot 604 in a desired position or pose when the manipulator robot 604 does not have a load in its grasp or to assist in lifting or supporting the weight of a grasped item.

In the example shown, the positioning robot 602 is movably mounted, at its proximal or (otherwise) fixed end, to a vertical post 606 via a vertical linear drive 608 configured to move the proximal end of the positioning robot 602 up and down along the vertical post 606. In various embodiments, vertical post 606 may be mounted on the floor and/or to the ceiling or to a wall of other structure.

In various embodiments, the manipulator robot 604 is moved into a desired position in three-dimensional space by using the vertical drive 608 to position the positioning robot 602 at a desired height (z coordinate) and using the position robot 602 to move the proximal (fixed) end of the manipulator robot 604 to a desired location in the x-y plane.

In various embodiments, a Cartesian robot having one or more of the following attributes is provided:
SCARA on vertical axis (ball screw or vertical lift), allowing cartesian workspace reach.
End of SCARA has a neutrally buoyant 3-4 DOF manipulator for orientation and small vertical movements.
Some: spring stronger than needed to support manipulator, motor pulls end down to grasp, neutrally buoyant when loaded.
   Or, vary spring strength f(load), like twisting rubber band.
Entire robot doesn't have to fight against gravity and can tackle a variety of tasks, e.g., shelf loading, palletization, and truck loading.
Allows for “ceiling mounted” design, reducing wrist collision risk.

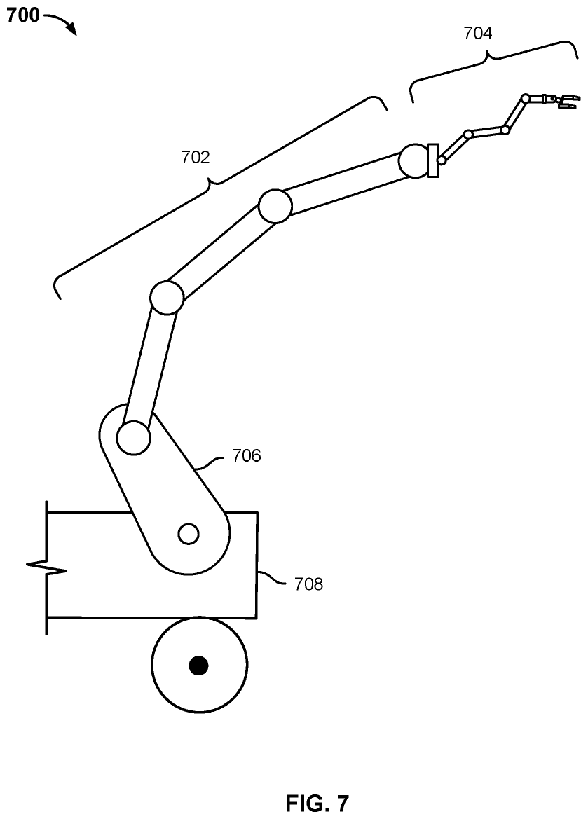

FIG. 7 illustrates an embodiment of a robot with m+n degrees of freedom. In the example shown, robot 700 includes a positioning robot 702 having a manipulator robot 704 mounted at a distal or free moving end of positioning robot 702. In this example, positioning robot 702 includes three segments connected by two “elbow” type joints, with the fixed or proximal end of the positioning robot 702 (left side as shown in FIG. 7) being mounted via a shoulder joint to a positioning cam 706, which in turn is rotatably mounted to a mobile base 708. In the example shown, manipulator robot 704 is a 7 DOF robotic arm, such as 7 DOF robotic arm 104 of FIG. 1.

In various embodiments, one or more robotic control techniques disclosed herein may be used to control and operate one or both of positioning robot 702 and manipulator robot 704. For example, n+1 control may be used to control the positioning robot 702 to move the manipulator robot 704 into position to perform a task, or “whole body” control of the joints comprising positioning cam 706 and positioning robot 702 may be used to move the manipulator robot 704 into position to perform the task. Alternatively, “whole body” control of the joints comprising positioning cam 706, positioning robot 702, and manipulator robot 704 may be used to perform the task.

As the examples shown in FIGS. 6 and 7 illustrate, techniques disclosed herein may be used to provide and control a robot comprising one or more positioning robots, of any type and number of DOFs, and one or more manipulator robots, of any type and number of DOFs, the combined assembly optionally being mounted on one or more of a vertical drive, a rail or other linear drive, and/or a mobile base, providing additional DOFs.

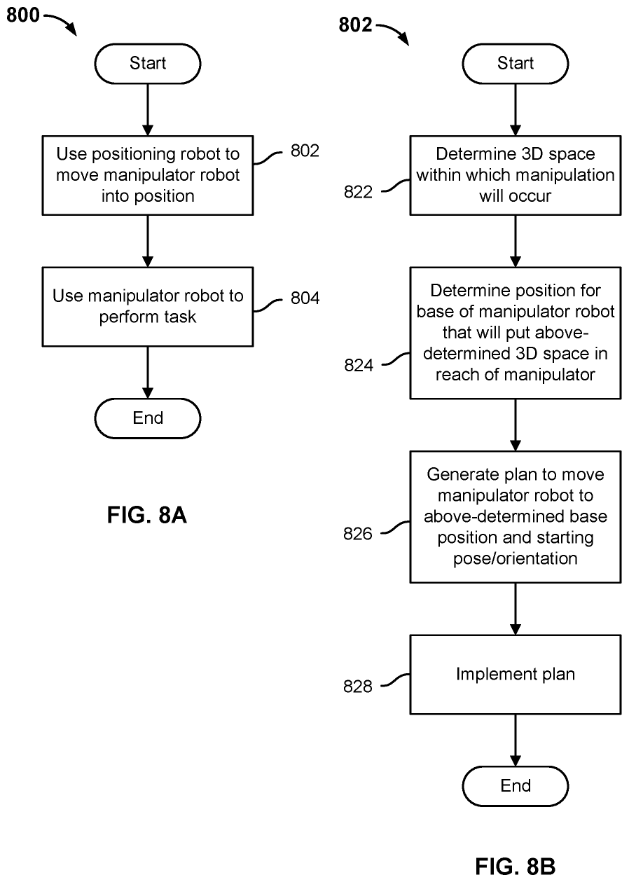

FIG. 8A is a flow diagram illustrating an embodiment of a process to control a robot having m+n degrees of freedom. In various embodiments, the process 800 of FIG. 8A may be performed by a control computer comprising a robotic system, such as control computer 216 of FIG. 2. In the example shown, at 802, a positioning robot is used to move a manipulator robot into position. At 804, the manipulator robot is used to perform a task.

FIG. 8B is a flow diagram illustrating an embodiment of a process to move a robot having m+n degrees of freedom into position to perform a task. In various embodiments, the process 802 of FIG. 8B may be performed by a control computer comprising a robotic system, such as control computer 216 of FIG. 2. In various embodiments, the process of FIG. 8B may be performed to implement step 802 of FIG. 8A. In the example shown, at 822, a region in three-dimensional space in which a task is to be performed is determined. For example, a region that includes a source location from which an item it to be picked and a destination location in which the item is to be placed may be determined at 822. Or, in another example, a region that includes multiple items and a space in which they are to be stacked may be determined. Or, if the task is to turn a knob, the space determined at 822 may be the space around the knob.

At 824, the operating space determined at 822 is used to determine the position to which a base or proximal end of the manipulator robot must be moved to place the manipulator robot in a position that enables the manipulator robot to reach at least applicable subparts of the space determined at 822. At 826, a plan is generated to operate the positioning robot to move the base of the manipulator robot into the position determined at 824. At 828, the plan generated at 826 is implemented.

In various embodiments, a robot having 7 or greater DOFs may include two or more robotic arms or other robots, which in various embodiments may have one or more structures and associated degrees of freedom in common. For example, a tree or tree-like design may be used, which includes a shared set of base structures and associated degrees of freedom that are common to the two robotic arms and additional degrees of free associated uniquely with one or the other of the robotic arms. In various embodiments, a tree or similar approach, in which some degrees of freedom are common to two or more robotic arms or other robotic instrumentalities, may be cost effective to build and operate and may result in lighter weight, energy savings, efficient use of space, and other benefits.

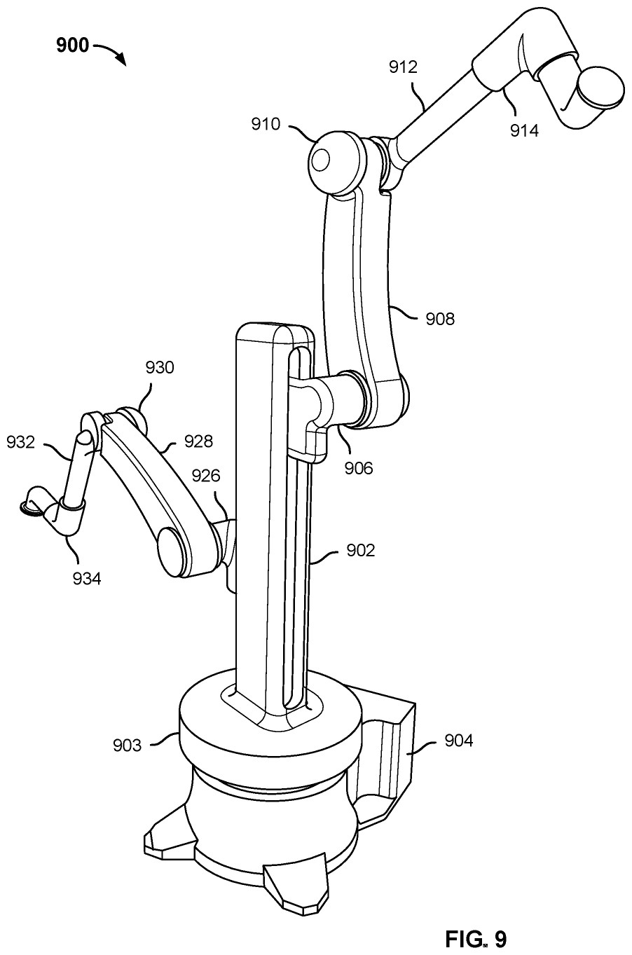

FIG. 9 illustrates an embodiment of a robot comprising two robotic arms. In the example shown, robot 900 includes a vertical post 902 fixedly coupled to a base 903, which in turn is rotatably mounted on a base 904. A robotically controlled motor, not shown in FIG. 9, enables the entire robot 900 to be rotated about a vertical axis of post 902. A first robotic arm assembly, comprising shoulder joint 906, upper arm segment 908, elbow joint 910, forearm segment 912, and wrist assembly 914 is movably mounted to vertical post 902, at shoulder joint 906. A second robotic arm assembly, comprising shoulder joint 926, upper arm segment 928, elbow joint 930, forearm segment 932, and wrist assembly 934 also is movably mounted to vertical post 902, at shoulder joint 926. Linear drive assemblies, not shown in FIG. 9, enable the first robotic arm assembly and the second robotic arm assembly to be moved, independently and/or in coordination, up and down the vertical post 902.

In various embodiments, the respective shoulder joints 906, 926 and elbow joints 910, 930 each provide a single DOF. The first robotic arm assembly and the second robotic arm assembly each have 7 (or more) DOFs, in various embodiments, including a shared DOF provided by rotation of the base 903 (and, therefore vertical post 902) relative to base 904, independent second DOFs provided by moving the shoulder 906, 926 up or down the vertical post 902, two additional DOFs (each) associated with the shoulder joints 906, 926 and elbow joints 910, 930, and three DOFs (roll, pitch, yaw) associated with the wrist assemblies 914, 934. Additional DOF's may be provided, e.g., rotation of the forearm segments 912, 932.

In various embodiments, the first robotic arm assembly and the second robotic arm assembly of robot 900 may be used separately, each to perform a different task, or jointly, e.g., to cooperate to pick up a large or heavy box or other item (e.g., bimanual manipulation). For example, robot 900 may be controlled to rotate the base 903 and vertical post 902, relative to the base 904, to position the first robotic arm assembly and the second robotic arm assembly on opposite sides of the item. The shoulders 906, 926 may be lowered and the first robotic arm assembly and the second robotic arm assembly may be used, in coordination, to grasp the item on opposite sides. The shoulders 906, 926 may then be raised to lift the box or other item above the floor, and some combination of rotation of the base 903 and post 902 relative to base 904 and operation of the first robotic arm assembly and the second robotic arm assembly may be performed to move the box to a destination location, at which it may be lowered into place by lowering the shoulders 906, 926, for example.

In various embodiments, one or both of the first robotic arm assembly and the second robotic arm assembly of robot 900 may be operating using “whole body” control or m+n control, as disclosed herein. For example, the shoulders 906, 926 may be used to position the first robotic arm assembly and the second robotic arm assembly, respectively, and then the first robotic arm assembly and the second robotic arm assembly may be controlled separately to perform the task(s), i.e., m+n control. Alternatively, “whole body” control of the shoulder plus robotic arm assembly, or rotating base 903 plus shoulder plus robotic arm assembly, may be performed.

While in FIG. 9 the base 904 is shown as a stationary or fixed base, in various embodiments one or more additional DOFs may be provided by mounting the base 904 on a movable structure, such as a rail or other linear track or on a mobile base.

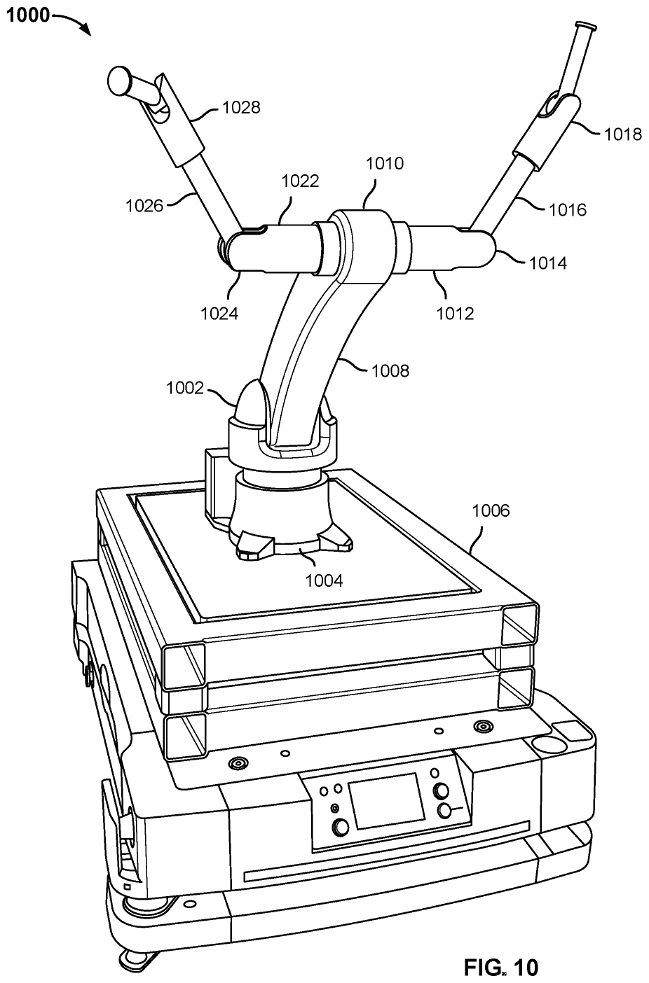

FIG. 10 illustrates an embodiment of a robot comprising two robotic arms. In the example shown, robot 1000 includes a shoulder joint 1002 rotatably mounted to a mount 1004 secured to a mobile base 1006. The shoulder joint 1002 provides the ability to pitch a shared upper arm segment 1008 about an axis of rotation of the shoulder joint 1002. A first robotic arm assembly comprising segment 1012, elbow joint 1014, forearm segment 1016, and wrist assembly 1018 and a second robotic arm assembly comprising segment 1022, elbow joint 1024, forearm segment 1026, and wrist assembly 1028 are each rotatably mounted at a distal end 1010 of segment 1008.

In various embodiments, one or more of the first robotic arm assembly, second robotic arm assembly, and the joints at distal end 1010, the bending of shoulder joint 1002, and rotation of should joint 1002 relative to base 1004 and, in some embodiments, additional DOFs provided by mobile base 1006 may be operated using either “whole body” or m+n control, as disclosed herein. In various embodiments, the first robotic arm assembly and the second robotic arm assembly may be used independently, each to perform a separate task, or jointly, e.g., to perform bimanual manipulation, such as to pick a large or heavy item.

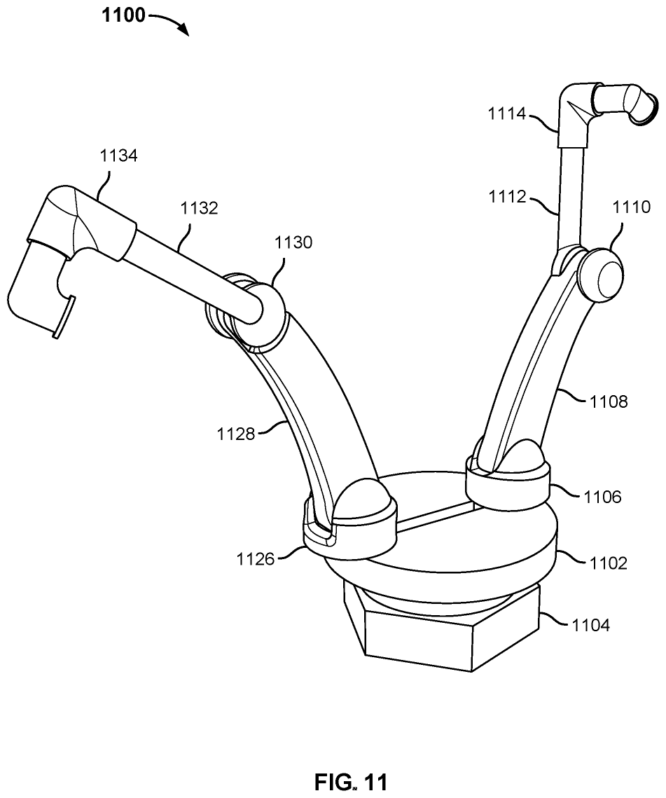

FIG. 11 illustrates an embodiment of a robot comprising two robotic arms. In the example shown, robot 1100 includes a turntable 1102 rotatably mounted on a base 1104. A first robotic arm assembly comprising shoulder 1106, segment 1108, elbow joint 1110, forearm segment 1112, and wrist assembly 1114 is movably coupled to turntable 1102. A drive mechanism not shown in FIG. 11 enables the first robotic arm assembly to be moved linearly along a groove or other guide along a chord of turntable 1102. For example, the shoulder 1106 may be moved inward or outward along a radial groove defined in the turntable 1102. Similarly, a second robotic arm assembly comprising shoulder 1126, segment 1128, elbow joint 1130, forearm segment 1132, and wrist assembly 1134 is movably coupled to turntable 1102, in a manner similar to the first robotic arm assembly.

In various embodiments, one or more of the first robotic arm assembly, second robotic arm assembly, and the drives configured to move the shoulders 1106, 1126 along the linear groove in turntable 1102, and the rotation of turntable 1102 and, in some embodiments, additional DOFs provided by mounting base 1104 on a mobile base may be operated using either “whole body” or m+n control, as disclosed herein. In various embodiments, the first robotic arm assembly and the second robotic arm assembly may be used independently, each to perform a separate task, or jointly, e.g., to perform bimanual manipulation, such as to pick a large or heavy item.

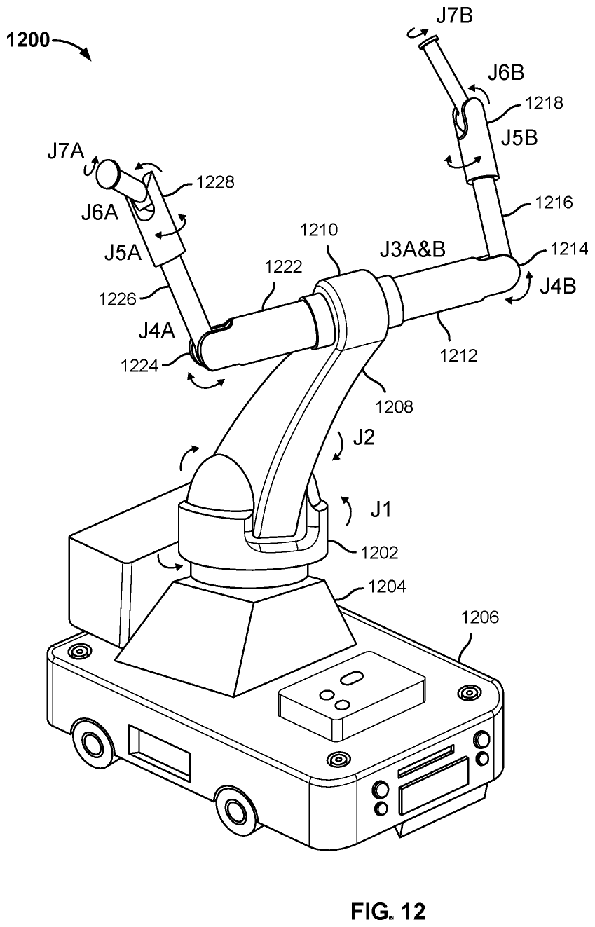

FIG. 12 illustrates an embodiment of a robot comprising two robotic arms. In various embodiments, robot 1200 of FIG. 12 is an example of an instance or implementation of a robot such as robot 1000 of FIG. 10, with various DOFs associated with one or both of the robotic arm assemblies labeled (e.g., “J7A” associated with just one arm, “J1” associated with both).

In the example shown in FIG. 12, robot 1200 includes a shoulder joint 1202 rotatably mounted to a mount 1204 secured to a mobile base 1206 to provide a first, shared DOF labeled “J1”. The shoulder joint 1202 provides the ability to pitch a shared upper arm segment 1208 about an axis of rotation of the shoulder joint 1202 (DOF “J2”). A first robotic arm assembly comprising segment 1212, elbow joint 1214 (“J4B”), forearm segment 1216, and wrist assembly 1218 (“J5B”, “J6B”, and “J7B”) and a second robotic arm assembly comprising segment 1222, elbow joint 1224 (“J4A”), forearm segment 1226, and wrist assembly 1228 (“J5A”, “J6A”, and “J7A”) are each rotatably mounted (“J3A”, “J3B”) at a distal end 1210 of segment 1208. As such, setting aside the DOFs provided by mobile base 1206, the robot 1200 includes for each robotic arm assembly a total of 7 DOFs, two of which are common to the two robotic arm assemblies, resulting in only one set of motors, motor controllers, gears, cables/wires, and other structures required to provide that DOF.

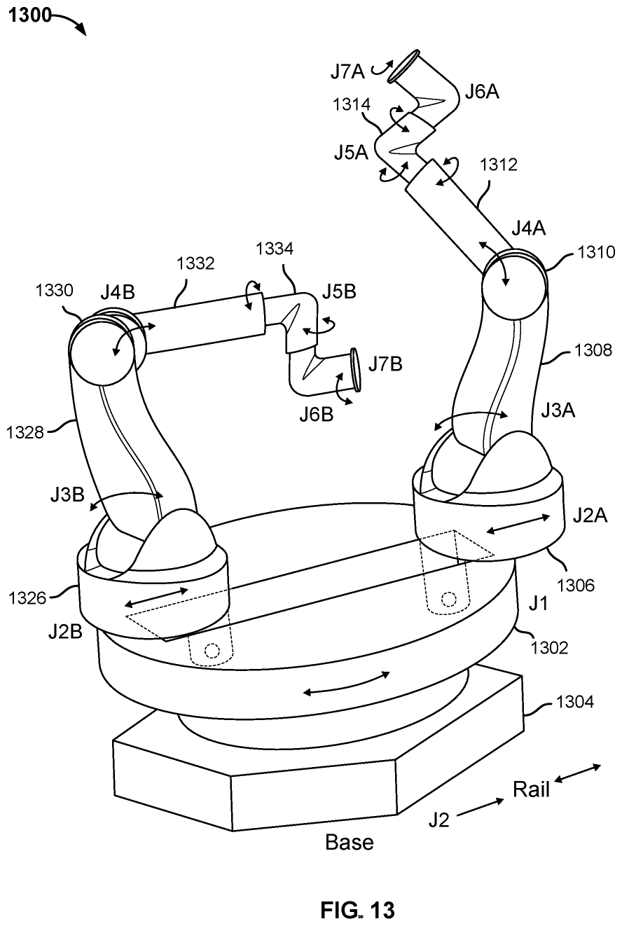

FIG. 13 illustrates an embodiment of a robot comprising two robotic arms. In various embodiments, robot 1300 of FIG. 13 is an example of an instance or implementation of a robot such as robot 1100 of FIG. 11, with various DOFs associated with one or both of the robotic arm assemblies labeled (e.g., “J7A” associated with just one arm, “J1” associated with both).

In the example shown in FIG. 13, robot 1300 includes a turntable 1302 rotatably mounted on a base 1304 (DOF “J1”). A first robotic arm assembly comprising shoulder 1306 (“J3A”), segment 1308, elbow joint 1310 (“J4A”), forearm segment 1312, and wrist assembly 1314 (“J5A”, “J6A”, and “J7A”) is movably coupled to turntable 1302 (“J2A). Similarly, a second robotic arm assembly comprising shoulder 1326 (“J3B”), segment 1328, elbow joint 1330 (“J4B”), forearm segment 1132, and wrist assembly 1134 (“J5B”, “J6B”, and “J7B”) is movably coupled to turntable 1102, in a manner similar to the first robotic arm assembly (“J2B”).

As in the example shown in FIG. 12, 7 DOFs are provided for each of two robotic arm assemblies, although in the example shown in FIG. 13 only one DOF (“J1”) is common to the two robotic arm assemblies.

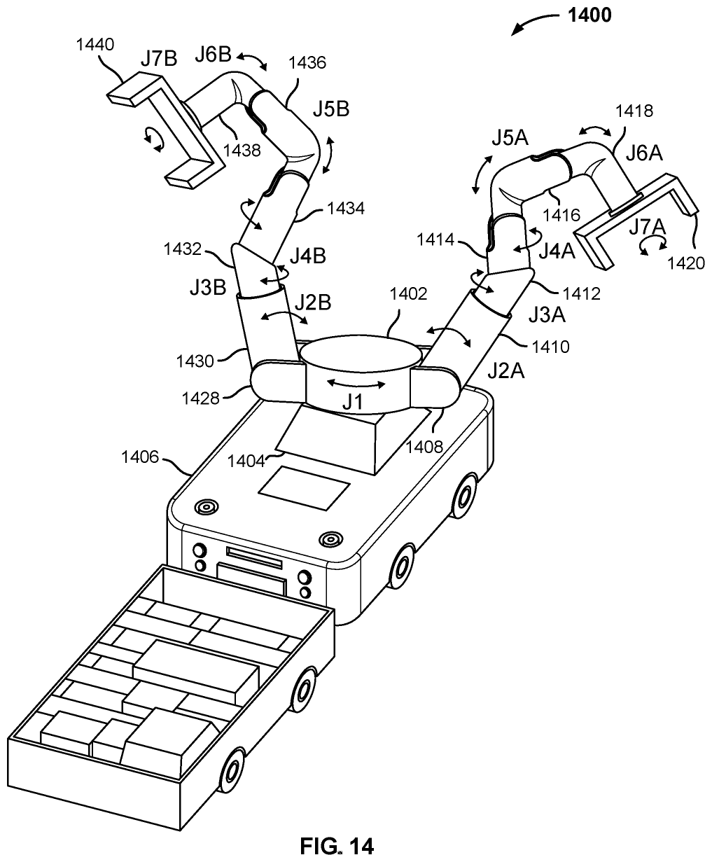

FIG. 14 illustrates an embodiment of a robot comprising two robotic arms. In the example shown, robot 1400 includes a turntable 1402 rotatably coupled (“J1”) to a base 1404 mounted on a mobile chassis 1406. Robot 1400 further includes a first robotic arm assembly mounted to the turntable 1402 via shoulder joint 1408 (“J2A”) and a second robotic arm assembly mounted to turntable 1402 via shoulder joint 1428 (“J2B”). The first robotic arm assembly includes, in addition to shoulder 1408, a segment 1410, segment 1412 (“J3A”), segment 1414 (“J4A”), and a wrist assembly 1418 (“J5A”, “J6A”, “J7A”) with an end effector 1420 attached thereto. The second robotic arm assembly includes, in addition to shoulder 1428, a segment 1430, segment 1432 (“J3B”), segment 1434 (“J4B”), and a wrist assembly 1438 (“J5B”, “J6B”, “J7B”) with an end effector 1440 attached thereto.

As in the example shown in FIG. 13, 7 DOFs are provided for each of two robotic arm assemblies, with one DOF (“J1”) being common to the two robotic arm assemblies.

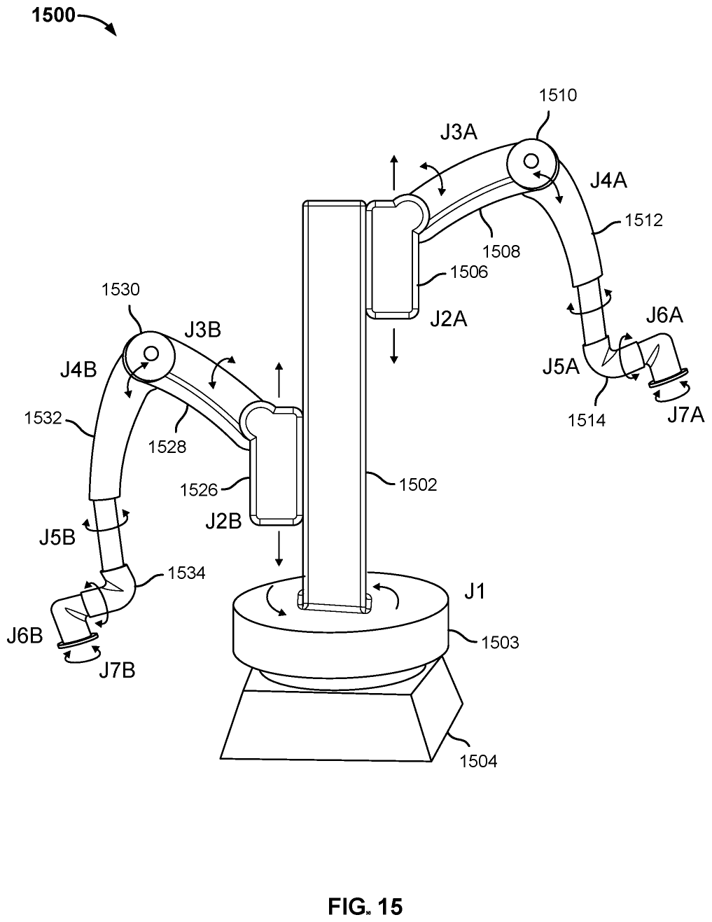

FIG. 15 illustrates an embodiment of a robot comprising two robotic arms. In various embodiments, robot 1500 of FIG. 15 is an example of an instance or implementation of a robot such as robot 900 of FIG. 9, with various DOFs associated with one or both of the robotic arm assemblies labeled (e.g., “J7A” associated with just one arm, “J1” associated with both).

In the example shown in FIG. 15, robot 1500 includes a vertical post 1502 fixedly coupled to a base 1503, which in turn is rotatably mounted on a base 1504. A robotically controlled motor, not shown in FIG. 15, enables the entire robot 1500 to be rotated about a vertical axis of post 1502 (“J1”). A first robotic arm assembly, comprising shoulder joint 1506 (“J2A”, “J3A”), upper arm segment 1508, elbow joint 1510 (“J4A”), forearm segment 1512, and wrist assembly 1514 (“J5A”, “J6A”, “J7A”) is movably mounted to vertical post 1502 (“J2A”), at shoulder joint 1506. A second robotic arm assembly, comprising shoulder joint 1526 (“J2B”, “J3B”), upper arm segment 1528, elbow joint 1530 (“J4B”), forearm segment 1532, and wrist assembly 1534 (“J5B”, “J6B”, “J7B”) also is movably mounted to vertical post 1502, at shoulder joint 1526 (“J2B”). Linear drive assemblies, not shown in FIG. 15, enable the first robotic arm assembly and the second robotic arm assembly to be moved, independently and/or in coordination, up and down the vertical post 1502 (“J2A”, “J2B”).

As in the examples shown in FIGS. 13 and 14, 7 DOFs are provided for each of two robotic arm assemblies, with one DOF (“J1”) being common to the two robotic arm assemblies.

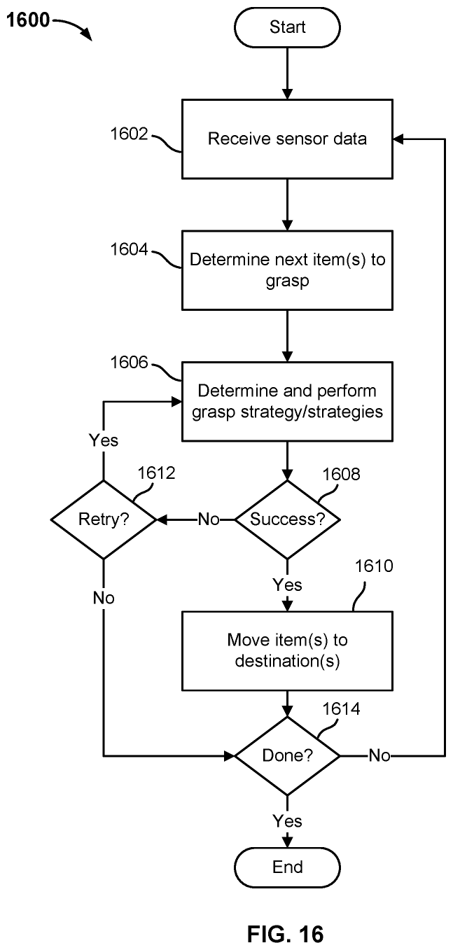

FIG. 16 is a flow diagram illustrating an embodiment of a process to control a robot comprising two robotic arms. In various embodiments, the process 1600 of FIG. 16 may be implemented by a control computer, such as control computer 216 of FIG. 2. In the example shown, at 1602, sensor data is received, e.g., form camera 210 of FIG. 2. At 1604, the next item(s) to be grasped is/are determined. For example, to perform robotic palletization, the next n items to be added to the pallet, and in which order, position, orientation, etc., may be determined. At 1606, a strategy to grasp each item is determined. If an item is grasped successfully (1608) it is moved to an associated destination (1610), e.g., placement on the designated location and orientation on the pallet. If the item is not grasped successfully, the system may try again (1612, 1606), e.g., up to a prescribed number of retries. If the prescribed number of retries has been reached or no further grasp strategy is available (1612) or once the item has been grasped and moved successfully (1608, 1610), it is determined at 1614 whether more items remain to be grasped. If so, the process returns to step 1602 and a further iteration of process 1600 is performed; if not, the process 1600 ends.

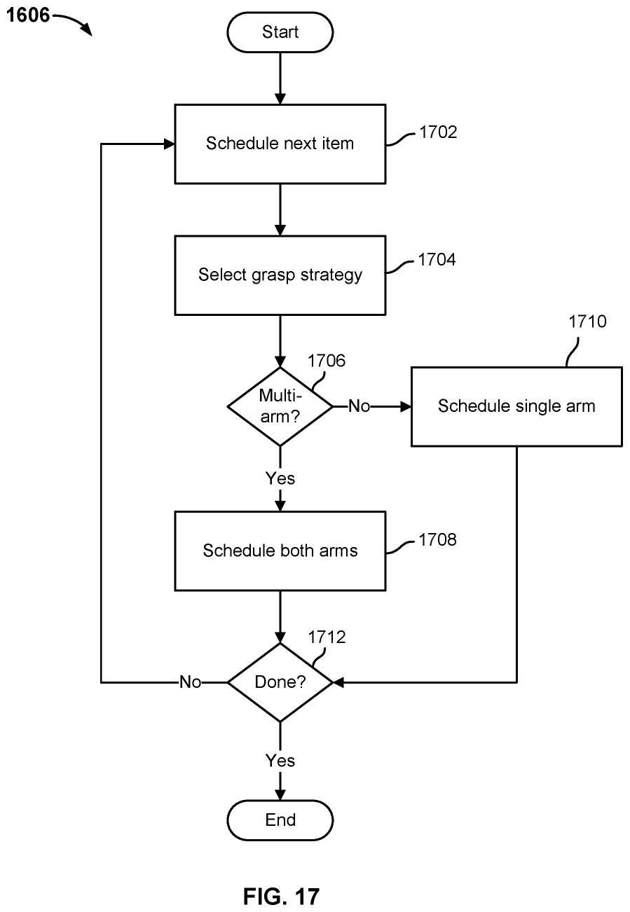

FIG. 17 is a flow diagram illustrating an embodiment of a process to control a robot comprising two robotic arms. In various embodiments, the process 1606 of FIG. 17 may be implemented by a control computer, such as control computer 216 of FIG. 2. In various embodiments, the process 1606 of FIG. 17 may be used to implement step 1606 of FIG. 16 with respect to a robot comprising two or more robotic arms, including without limitation the robots shown in FIGS. 9 through 15.

In the example shown, at 1702, a next item to be handled (e.g., picked/placed) is scheduled (i.e., planned). At 1704, a strategy to grasp the item is selected. If the strategy selected at 1706 involves grasping the item with two (or more) arms, then at 1708 both (or all participating) arms are scheduled to grasp the item, cooperatively, each participating as indicated by the multi-arm grasp strategy selected at 1704. If, instead, a strategy to grasp the item using a single arm was selected at 1704, 1706, then at 1710 that single arm is scheduled to grasp the item, using the strategy selected at 1710. Once the arm(s) participating in grasping the item have been scheduled (1708, 1710), it is determined at 1712 whether further items remain to be handled. If so, the process 1606 returns to 1702 and a subsequent iteration of the process of FIG. 17 is performed; if not, the process 1606 ends.

Various embodiments of robots having seven or more DOF have been disclosed. In various embodiments, one or more of new, lightweight motor designs; new and/or different motor placement; co-location of motor controllers and the motors they drive; simplified gear designs, such as planetary gears; and multi-arm (e.g., “tree” style) designs have been disclosed as being used to provide a robot having seven or more DOF while achieving high performance, throughput, durability, and safety.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1.-20. (canceled)

21. A robotic system, comprising:
a communication interface; and
a processor coupled to the communication interface and configured to control, via communication sent via the communications interface, a robot comprising a positioning robot having m degrees of freedom, a first base end, and a first free moving end and a manipulator robot having n degrees of freedom, the manipulator robot having a second base end coupled mechanically to the first free moving end of the positioning robot and a second free end configured to have a robotic end effector mounted thereon;
wherein processor is configured to control the robot in a first mode of operation, in which the positioning robot is controlled to move the manipulator robot into a position to perform a task and the manipulator robot is controlled independently of the positioning robot to perform the task; and in a second mode of operation, in which at least a subset of the m degrees of freedom of the positioning robot and at least a subset of the n degrees of freedom of the manipulator robot are controlled together, by a single controller, to perform the task.

22. The robotic system of claim 21, wherein the processor is configured to select the first mode of operation or the second mode of operation to perform the task.

23. The robotic system of claim 22, wherein the processor is configured to use one or more of a machine learning model, a rule, a heuristic, and a selection criterion to select the first mode of operation or the second mode of operation to perform the task.

24. The robotic system of claim 22, wherein the processor is configured to use one or more of a machine learning model, a rule, a heuristic, and a selection criterion to select the first mode of operation or the second mode of operation to perform the task.

25. The robotic system of claim 22, wherein the processor is configured to use an attribute data associated with the task to select the first mode of operation or the second mode of operation to perform the task.

26. The robotic system of claim 25, wherein the attribute comprises an attribute of an item to be manipulated to perform the task.

27. The robotic system of claim 25, wherein the attribute is determined based at least in part on sensor data received via the communication interface.

28. The robotic system of claim 21, wherein the manipulator robot comprises a first manipulator robot and the robot further includes a second manipulator robot coupled to the positioning robot and wherein the processor is configured to determine to use the first manipulator robot, the second manipulator robot, or both the first manipulator robot and the second manipulator robot to perform the task.

29. The robotic system of claim 28, wherein the processor is further configured to control the positioning robot to position one or both of first manipulator robot and the second manipulator robot to perform the task.

30. The robotic system of claim 21, wherein the processor is configured to use one or more joints comprising the positioning robot to hold the manipulator robot in place, in a desired pose of the manipulator robot, including while the manipulator robot has an item in its grasp.

31. The robotic system of claim 21, wherein the processor is configured to apply torque to one or more joints comprising the positioning robot to slow movement and counteract momentum of the manipulator robot as the second base end of the manipulator robot approaches a target location in three-dimensional space.

32. The robotic system of claim 21, wherein the processor is configured to begin to operate the manipulator robot as required to perform the task while the positioning robot is still being used to move the manipulator robot into position to perform the task.

33. A method of controlling a robot comprising a positioning robot having m degrees of freedom, a first base end, and a first free moving end and a manipulator robot having n degrees of freedom, the manipulator robot having a second base end coupled mechanically to the first free moving end of the positioning robot and a second free end configured to have a robotic end effector mounted thereon, the method comprising:
controlling the robot in a first mode of operation, in which the positioning robot is controlled to move the manipulator robot into a position to perform a task and the manipulator robot is controlled independently of the positioning robot to perform the task; and
controlling the robot in a second mode of operation, in which at least a subset of the m degrees of freedom of the positioning robot and at least a subset of the n degrees of freedom of the manipulator robot are controlled together, by a single controller, to perform the task.

34. The method of claim 33, further comprising determining for a given task whether to control the robot in the first mode of operation or the second mode of operation.

35. A computer program product to control a robot comprising a positioning robot having m degrees of freedom, a first base end, and a first free moving end and a manipulator robot having n degrees of freedom, the manipulator robot having a second base end coupled mechanically to the first free moving end of the positioning robot and a second free end configured to have a robotic end effector mounted thereon, the method comprising, the computer program product being embodied in a non-transitory computer readable medium and comprising computer instructions for:
controlling the robot in a first mode of operation, in which the positioning robot is controlled to move the manipulator robot into a position to perform a task and the manipulator robot is controlled independently of the positioning robot to perform the task; and
controlling the robot in a second mode of operation, in which at least a subset of the m degrees of freedom of the positioning robot and at least a subset of the n degrees of freedom of the manipulator robot are controlled together, by a single controller, to perform the task.

36. The method of claim 34, further comprising using an attribute data associated with the task to select the first mode of operation or the second mode of operation to perform the task.

37. The method of claim 36, wherein the attribute comprises an attribute of an item to be manipulated to perform the task.

38. The method of claim 33, wherein the manipulator robot comprises a first manipulator robot and the robot further includes a second manipulator robot coupled to the positioning robot and further comprising determining to use the first manipulator robot, the second manipulator robot, or both the first manipulator robot and the second manipulator robot to perform the task.

39. The method of claim 33, further comprising beginning to operate the manipulator robot as required to perform the task while the positioning robot is still being used to move the manipulator robot into position to perform the task.

40. The method of claim 33, further comprising applying torque to one or more joints comprising the positioning robot to slow movement and counteract momentum of the manipulator robot as the second base end of the manipulator robot approaches a target location in three-dimensional space.
